(19) United States
(12) Patent Application Publication
(10) Pub. No.: US 2010/0011960 A1
(43) Pub. Date: Jan. 21, 2010

(54) Electrostatic Air Filter

(76) Inventor: Colin Lawrence, East Sussex (GB)

Correspondence Address: Calin Lawrence Amess, 37 Willingdon Road, Eastbourne, BN21 1TN, omitted

(21) Appl. No.: 11/995,720

(22) PCT Filed: Jul. 18, 2005
(86) PCT No.: PCT/GB2005/002833

§ 371 Date: Jan. 16, 2008

(51) Int. Cl. B03C 3/45; B03C 3/00

(52) U.S. Cl. 96/27; 96/100; 96/61

(57) ABSTRACT

The invention provides a filter for separating very small particles or organisms from the air or gas in which they are carried, comprising a filter mechanism and a duct, chamber or pipe to contain and transport the air or gas and to house the filter mechanism; the filter mechanism comprising: a particle charging means, a means to introduce charged or uncharged atomized droplets of liquids or reagents into the air or gas after the particle charging stage, and a capture means for collecting the atomized droplets and/or very small particles or organisms.

### FIELD OF THE INVENTION

The present invention relates to the electrostatic removal of small particulates and organisms from the air. More particularly, the invention relates to a device and method for increasing the collection efficiency of very small particles when compared with conventional electrostatic filters.

### DESCRIPTION OF THE PRIOR ART

Conventional Electrostatic devices pass air (or gas) through a chamber. The chamber is arranged to electrostatically charge small particles suspended in an air stream passed in close proximity to a high voltage corona device. The small particles become charged due to the resultant electric field of the corona. The air and charged particles are then passed axially between conductive surfaces that are charged to a high voltage. The charged particles experience a force that is the product of the particles charge and the electric field strength between the plates. The charged particles migrate towards plates of opposite polarity due to the impressed electrostatic forces between the plates and the particles.

As particle sizes decrease, the drag forces predominate the inertial mass forces. As a practical consequence, the maximum velocity that can be achieved by small particles normal to the inlet/outlet air stream reduces sharply with reducing particle sizes below 0.2 microns. If it is required to obtain a high collection quotient of these smaller particles in conventional plate type precipitators, then the volume of air that passes through the chamber in a given unit of time will have to be de-rated or, alternatively, the size of the collection plates (and hence volume of the chamber) increased.

### SUMMARY OF THE INVENTION

According to the present invention there are provided separate means to enable higher collection efficiencies of very small particles for given precipitator chamber volumes and input airflow volume rates when compared to conventional means. In the context of the invention, small particles means: a body or material down to the nanometer scale Accordingly, organisms such as the S.A.R.S. virus (around 60 nanometers) could be removed from the air. The ability to filter air or gas at the nanometer level opens up the possibility of improving nuclear, chemical and biological protection systems as well as a means of capturing air borne pollutants for sample analysis.

The invention provides a filter for separating very small particles or organisms from the air or gas in which they are carried, comprising a filter mechanism and a duct, chamber or pipe to contain and transport the air or gas and to house the filter mechanism; the filter mechanism comprising:
a particle charging means,
a means to introduce charged or uncharged atomized droplets of liquids or reagents into the air or gas after the particle charging stage, and
a capture means for collecting the atomized droplets and/or very small particles or organisms; the capture means comprising one or more of:
a) a maze of fine wire or filament conductors held at a high voltage and through which the air or gas is passed,
b) a plurality of vertically orientated filaments held at high voltage and through which the air or gas is passed, or
c) one or more vertically orientated collector plates held at high voltage.

There is also provided a filter for separating very small particles or organisms from the air or gas in which they are carried, comprising a filter mechanism and a duct, chamber or pipe to contain and transport the air or gas and to house the filter mechanism; the filter mechanism comprising:
a particle charging means, and
a capture means for collecting the very small particles or organisms; the capture means comprising a maze of fine wire or filament conductors held at a high voltage and through which the air or gas is passed.

Filters according to the invention may be used to remove particles of from 20 nm to 100 μm (preferably from 50 nm to 10 μm) from the air or gas in which they are held.

### DESCRIPTION OF THE DRAWINGS

The drawings labeled from FIG. 1 to FIG. 5 illustrate the generic mechanisms employed in the invention. This series of schematic figures is provided for simplification. Each schematic figure is a construction of a number of modules; each module represents a cross-sectional side elevation of a functional part constructed within a box section for the further purposes of simplification and identification of each module. The above figures show each module slightly separated. In practice, all modules butt up to adjoining modules with no gaps between the modules so as to form a continuous chamber. FIG. 6 illustrates a working model of one configuration that includes provision for the continuous supply of liquid and the continuous removal of excess waste liquid.

FIG. 1 illustrates an orientation where contaminated air is drawn into a horizontal chamber and atomizer stage. The air is then drawn vertically through a vertical collector stage allowing excess droplets to fall into a collection receptacle.

FIG. 2 illustrates an entirely horizontal chamber.

FIG. 3 illustrates a simple centrifuge incorporated into the collection stage

FIG. 4 illustrates a simple cyclone incorporated into the collection stage.

FIG. 5 illustrates a basic filter mechanism that does not employ the use of aerosols.

### DETAILED DESCRIPTION

The present invention employs the use of a spun conductive filament, or fine wire held at high voltage that takes a similar place to a high voltage plate collector in a conventional electrostatic precipitator, excepting that the air (or gas) to be cleaned is passed through the mesh of the conductive filament instead of parallel to the material, as in the case of conventional electrostatic precipitator. The effect of this arrangement is to increase the available collection surface area/plate volume ratio and reduce the mean distance between charged particles and the collection surfaces for a given volume of chamber. Additionally, as the air passes around the filaments, the airflow will become turbulent, forming multiple eddies. The direction of travel of the particles within the eddies will become chaotic and transiently deviate the path of the particles across the direction of the average movement of the air through the chamber. In consequence of this substantially non-laminar airflow, the charged particles will, for at least part of their journey through the filament collector, experience a velocity vector reinforcing the attraction force vector towards the collector.

A further enhancement may be made to the particle collection efficacy by introducing atomized droplets after the corona stage and before the collector filaments The small droplets produced by the atomizer may be charged positively, negatively or at zero potential depending on the polarity of the corona and collector.

One method of charging the aerosols may include inductive charging whereby the aerosol generator housing comprises an insulated container with an outer conductive coating and an inner insulated electrode-having contact with the source liquid for atomizing. A switch to connect and disconnect insulated electrode to the desired electrical potential and a further switch to connect or disconnect the conductive coating on the aerosol generator housing to a desired electrical potential. The switches are opened and closed to provide a charge pump at the desired rate to. Another method to charge the aerosols can be achieved by the direct connection of the source liquid for atomizing to a high voltage generator of the chosen polarity.

Mixing of the charged particles and the atomized droplets may be enhanced by the action of a Venturi chamber. Since the charged particles are brought into very close proximity with the atomized droplets, the electrostatic attraction between particles and droplets will be high causing small particles to collide with the relatively massive droplets. Once collision occurs, the particle will be held to the droplet under the forces of surface tension.

If the collector filaments are packed tightly, they will substantially obstruct the combined particles and atomized droplets. When the droplets impact on the filament, they will cling to it under the forces generated by surface tension, similarly, other small droplets will collide and, in turn, merge with the clinging droplets to form bigger droplets. As the bigger droplets form, a point will be reached where the gravitational forces will exceed the surface tension forces that make the droplets cling to the filaments. Furthermore, as droplets and their trapped particles merge to form larger composites, gravitational forces will dominate the surface tension forces allowing the composite droplets to fall to a collection receptacle without being swept further into the chamber by the air flowing through the chamber. It is obvious that a centrifuge or a cyclone system could be used to provide centripetal forces many times greater than the force due to Earths gravity to enhance this mechanism.

The voltage applied to the conductive filament may be arranged such that there is a large potential difference between the filament and atomized droplets purposefully introduced after the Corotron or corona stage. If the atomized droplets are of negative charge with respect to the positively charged particles (or vice versa) that have passed through the corona stage, then there will be a mutual attraction between the particles and the droplets as described above.

When the particles and droplets impact on each other, the relatively massive droplets trap the smaller particles and their charges are shared. Because the filaments are electrically arranged to be at a high voltage of differing potential of the droplets, a strong electrical field will exist between filament and the composite droplets. When the droplets and composite droplets come into close proximity of the charged filament, they will experience an electrostatic force towards the filament and can be accelerated to a much larger terminal velocity towards the filament before equilibrium between electrostatic and drag forces are reached when compared the terminal velocities that can be achieved by the much smaller particles alone.

It should be appreciated, that the electrostatic field within the filament maize will be at equipotential between the filaments. There will be a local distortion in the field only when a suspended charged particle or particles are present. The collection electrode is therefore insensitive to direct short circuits due to long fibers bridging the collection electrode.

It is also possible to arrange for the thin filament conductors to be very closely tensioned and positioned in a vertical plane with the straight, vertical conductors very closely spaced to each other. This configuration of the conductive collectors allows for a path of minimal vertical obstruction for the droplets to run down while maintaining substantially obstructive path to aerosols traveling axially along the collection chamber.

The use of aerosols may also be integrated into conventional flat plate collectors where provision is made for the aerosols and smaller particles to mix thoroughly prior to the charged collector plates. The combined droplets and smaller particles may be collected from the surfaces of the flat plates. If the collector plates are mounted vertically, this orientation will assist the collected droplets and particles to run-off allowing them to be caught in a recovery vessel.

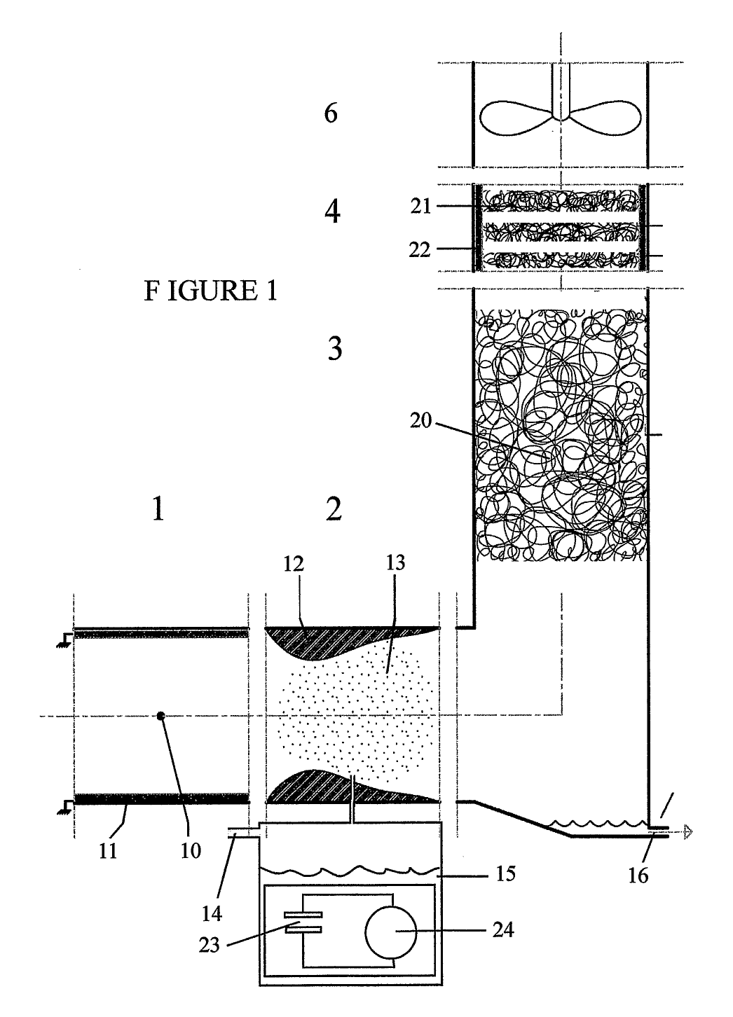

FIG. 1 shows a cross-sectional schematic representation of the filter. The filter comprises a corona charging stage 1, an option for an atomizing stage 2, a filament collector stage 3, an earthed stage 4 and a fan 6 to draw air through the duct. The functionality of the filter is such that; when the air is passed through the charging stage, particles drawn in with the air become charged due to the corona induced movement of ionized gas molecules and the high electric field. The corona is formed around a fine wire 10 and in this case, is shown to be at a high positive potential with respect to the electrodes 11 which are shown earthed. The air and positively charged particles continue to be drawn along the duct where they meet the atomizing stage. The stage may have a shaped throat 12 to provide a Venturi effect and to assist the formation and mixing of atomized droplets. The atomizer consists of a piezo vibrating plate 23 in contact with the desired liquid 15 held at some voltage, which, in this case is held at earth potential. An oscillating voltage generator 24 powers the piezo plate. The voltage generator may be tuned from several tens of kilohertz to several megahertz depending on the required size of atomized droplets and the resonance of the piezo. Droplets 13, of size ranging in the order of between one to twenty microns can readily be formed depending on the chosen oscillation frequency and the surface tension of the liquid employed. The desired liquid 15 could be water, oil or reagents chosen to react with specific chemical or biological particles that need to be neutralized and removed from the air. The liquid may, for example, contain finely ground carbon to absorb volatile aromatic hydrocarbons, or, alternatively, agents to destroy viruses or bacteria. As the droplets and the particles pass into close proximity with each other, many charged particles will merge with the atomized droplets as they impact due to mutual electrostatic attraction. As the remaining droplets and particles are drawn into the maize of filament 20 that is held at high negative voltage, there will be further and more effective mixing of the particles and droplets in the chaotic or turbulent airflow between the filament strands. As the droplets and particles are brought into very close proximity with each other, the mutual electrostatic attraction forces increase proportionally to the inverse square of the distances between the droplets and particles. Additionally, electrostatic forces between the high voltage filament, particles, droplets and combined or merged droplet particles cause their migration to the filament. The larger droplets migrate the fastest due to their higher terminal drag equilibrium velocity. The smaller remaining particles migrate more slowly due to their lower terminal velocities, which are restricted by higher drag coefficients. The air streaming around the filament carries the droplets into very close proximity to the filament. Because of this close proximity, the resultant electrostatic forces on the particles are high, therefore, the resultant time that is required for even small particles to migrate to the filament is small in comparison to the migration time of small particles migrating across a laminar airflow in a comparatively widely spaced conventional flat plate electrostatic precipitator. Droplets and their captured particles drip into the collection chamber from which the contaminated liquid can be extracted via the outlet 19. Any charged particles that manage to escape the collection hamber are then passed through the earthed filaments in the earthing stage 4 as a final filter and charge neutralizer.

The above description describes a positive charging device or Corona, an earthed liquid to be atomized and a negatively charged collector filament. Since the resultant electrostatic fields are proportional to the potential differences. It is obvious that the given polarities can be reversed or biased to achieve the substantially the same effect.

The following figures illustrate some variations achievable within the embodiment of the invention and are not intended to be restrictive. The principle functioning parts retain the same number references as in FIG. 1 unless otherwise stated.

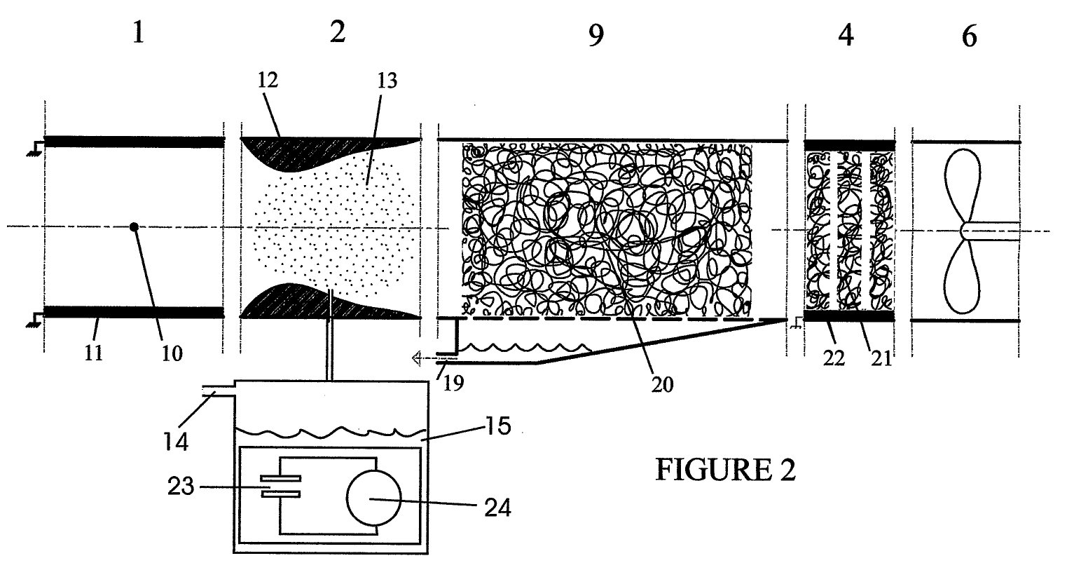

FIG. 2 shows a physical configuration that differs from FIG. 1 in that the collection chamber is aligned horizontally on the same axis of the charging and mixing stage. Droplets and their captured particles drip into the collection chamber 9, from which the contaminated liquid can be extracted via the outlet 19. It should be obvious that the orientation of each stage may be positioned to allow the maximum flexibility in the manufacturing design process.

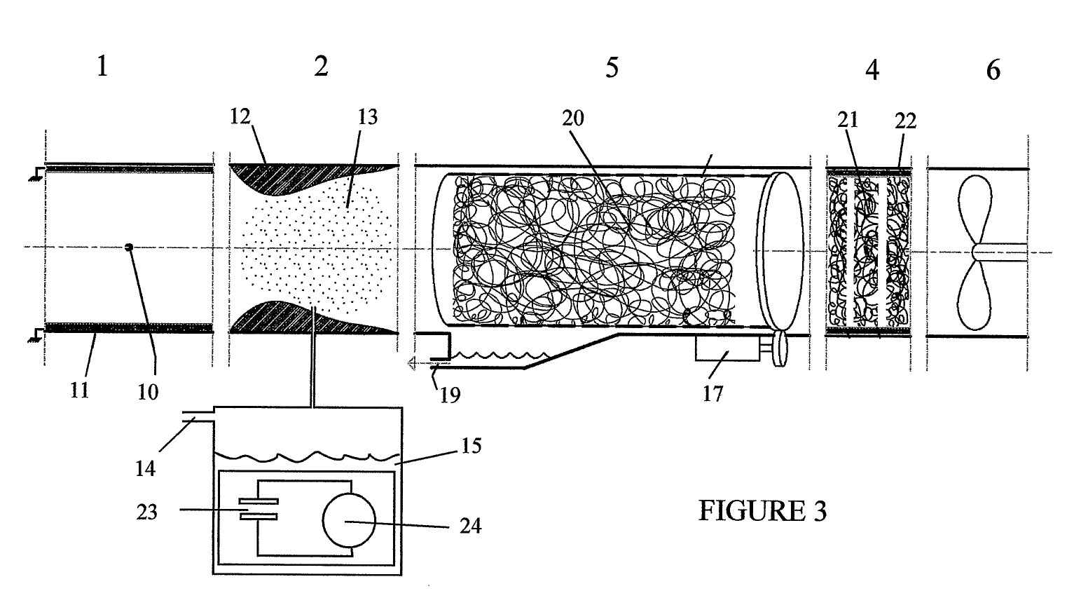

FIG. 3 shows a simple configuration whereby a motor assembly 17 rotates the inner chamber of the collection stage 5 and its contents. As the filament chamber rotates, the contaminated liquid comprised of the droplets and particles is thrown through the perforated filament support chamber onto the walls of the stationary outer collection cylinder jacket. The contaminated liquid is removed via the drain port 19.

It is obvious that there are many other electro mechanical configurations that could be used to rotate the collection stage.

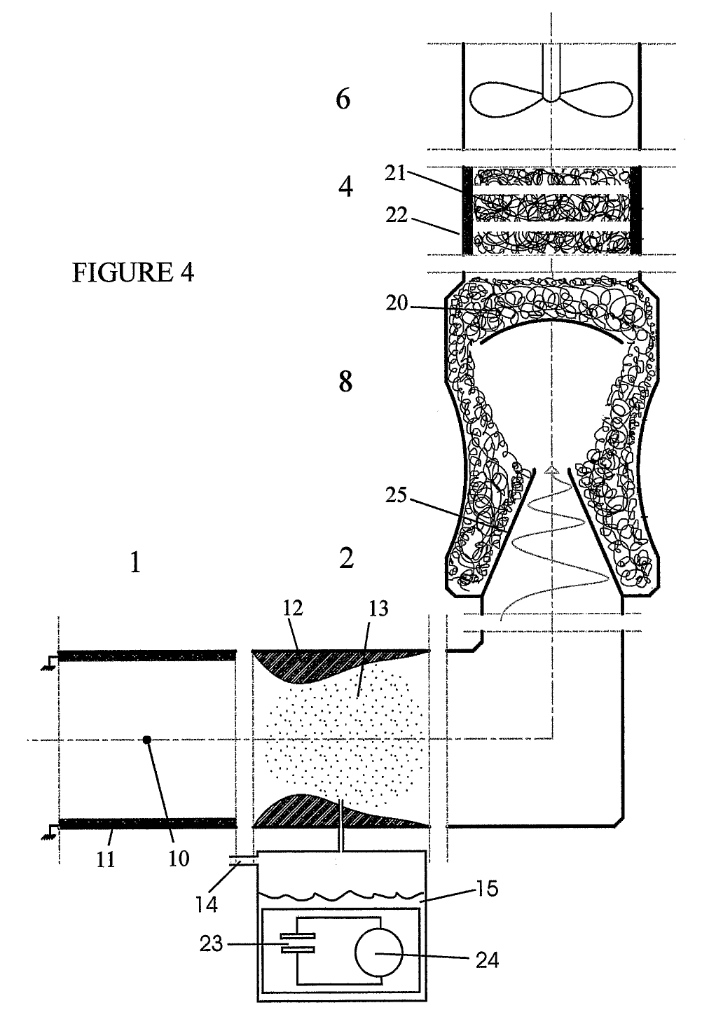

FIG. 4 shows a configuration whereby the collection chamber 8 incorporates a cyclone 25. The contaminated liquid comprised of the droplets and particles is thrown onto the conductive filament 20 that is held at a high voltage and also onto the inside of the outer wall of the cyclone chamber. The contaminated liquid is removed from the bottom of the cyclone chamber via a drain port.

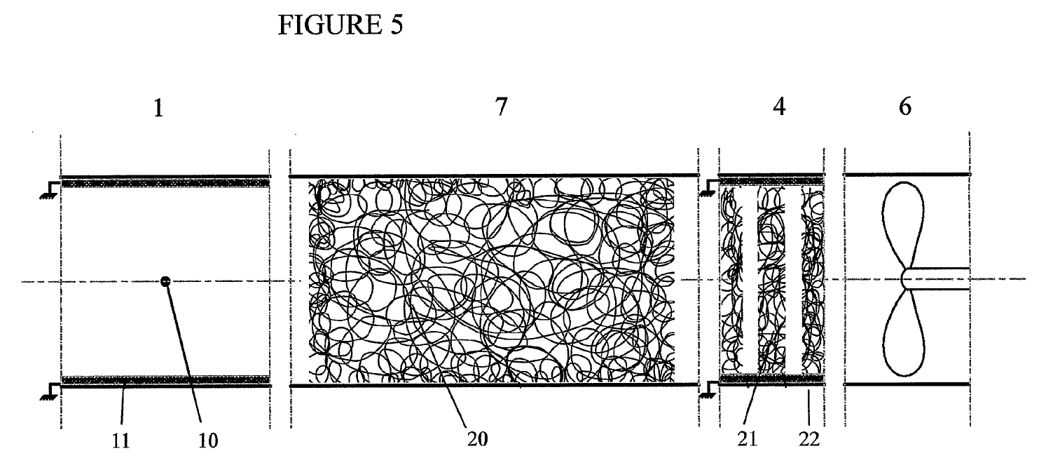

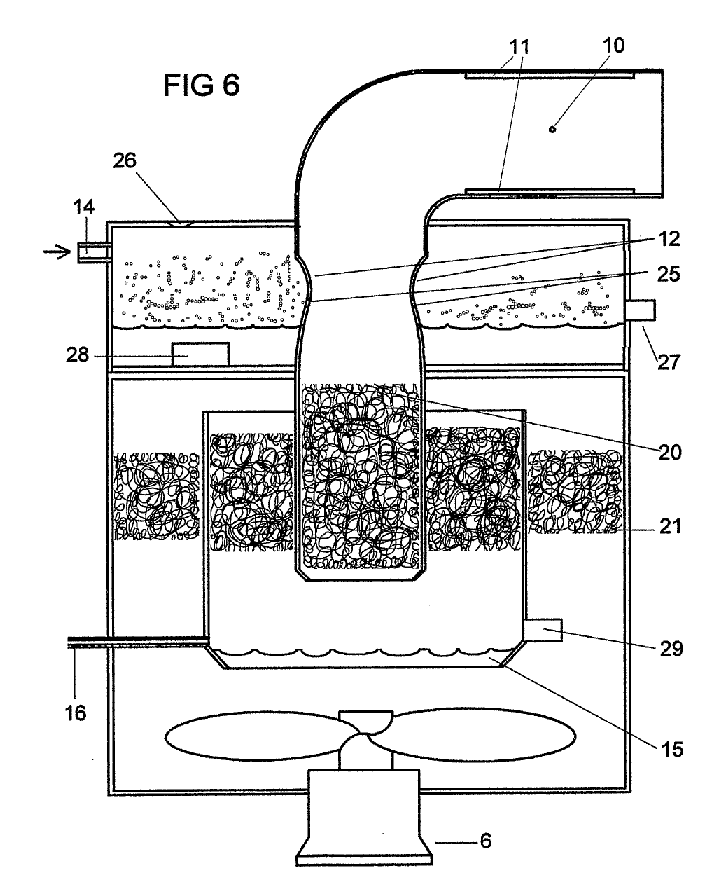

A conductive maze of filament or fine wire held at a high voltage 20 can be provided to enable higher collection efficiencies of very small particles for given precipitator chamber volumes and input airflow volume rates when compared to conventional means. As described above in the invention summary, this mechanism may be employed without the inclusion of charged aerosols or an atomizing stage as shown in FIG. 5. The fine wire filament maze can be manufactured inexpensively and can be a disposable item.

FIG. 6 shows a configuration that provides for an annular atomizing chamber whereby the aerosols are drawn into the throat of the venturi through small holes 25 spaced radially around the circumference of the throat. A small quantity of air is allowed into the atomizer chamber via a small vent 26 to maintain a positive pressure differential from the atomizing chamber into the throat of the venturi.

A liquid level detector 27 can -be used to detect a low liquid level and signal the manual replenishment of the liquid or provide the initiation signal requesting the automatic replenishment of the liquid into the atomizer chamber from a master supply. The composite piezo transducer assembly 28 is immersed below the liquid held in the insulated annulus that forms the atomizing chamber.

A further liquid level detector 29 can be used to detect a surplus of collected contaminated liquid and provide a signal requesting the manual extraction of the liquid or provide the initiation signal of an automatic extraction of the surplus liquid into a further storage receptacle.

1. A filter for separating very small particles or organisms from the air or gas in which they are carried, comprising a filter mechanism and a duct, chamber or pipe to contain and transport the air or gas and to house the filter mechanism; the filter mechanism comprising:
a particle charging means,
a means to introduce charged or uncharged atomized droplets of liquids or reagents into the air or gas after the particle charging stage, and
a capture means for collecting the atomized droplets and/or very small particles or organisms; the capture means comprising one or more of:
a) a maze of fine wire or filament conductors held at a high voltage and through which the air or gas is passed,
b) a plurality of vertically orientated filaments held at high voltage and through which the air or gas is passed, or
c) one or more vertically orientated collector plates held at high voltage.

2. A filter as claimed in claim 1, wherein the charged or uncharged atomized droplets are of a controlled size.

3. A filter as claimed in claim 1 or claim 2, further comprising a Venturi mixing stage at the point wherein the charged or uncharged atomized liquids or reagents of a controlled size are introduced into the air or gas after the particle charging stage.

4. A filter as claimed in any preceding claim, further comprising means to monitor the liquid or reagent supply and to maintain a constant supply thereof.

5. A filter as claimed in any preceding claim, further comprising means for removing precipitated liquid or reagent from the capture means.

6. A filter as claimed in any preceding claim, wherein the capture means comprises a maze of fine wire or filament conductors held at a high voltage.

7. A filter for separating very small particles or organisms from the air or gas in which they are carried, comprising a filter mechanism and a duct, chamber or pipe to contain and transport the air or gas and to house the filter mechanism; the filter mechanism comprising:
a particle charging means, and
a capture means for collecting the very small particles or organisms; the capture means comprising a maze of fine wire or filament conductors held at a high voltage and through which the air or gas is passed.

8. A filter as claimed in claim 6 or claim 7, wherein the capture means may be rotated to impress centripetal forces on the contents thereof in order to separate the contents.

9. A filter as claimed in any preceding claim, wherein the particle charging means comprises a corona.

10. A filter as claimed in any preceding claim, wherein the capture means is retained in a detachable section so that it may be removed for cleaning and/or disposal.

11. A filter as claimed in any preceding claim, comprising a plurality of capture means.

12. A filter as claimed in claim 11, wherein each capture means may be held at different voltages and/or polarities.

13. A filter as claimed in any preceding claim, wherein the collection stage incorporates a cyclone separator.

14. A filter as claimed in any preceding claim, comprising a means to neutralise any residual ions or charges in the cleaned air or gas.

15. A filter as claimed in claim 14, wherein the neutralising means comprises an earthed conductive screen mesh.

16. A filter as claimed in any preceding claim, comprising an integral fan for drawing air through the filter.

17. A filter as claimed in any of claims 1 to 15, for use with a pressurised air or gas conductor or conduit.

18. A filter as claimed in any of claims 1 to 15, for use in a motor vehicle's exhaust system.

19. A filter as claimed in any of claims 1 to 15, for use in the exhaust airflow of a domestic or commercial vacuum cleaner.

20. A filter as claimed in any of claims 1 to 15, for use in the exhaust airflow of a cyclone separator or filter.

21. A filter as claimed in any of claims 1 to 16, for use in an air conditioning system.

22. A filter as claimed in any of claims 1 to 16, for use as a portable filter or as a sub assembly of a face mask for personal protection.
